(19) United States
(12) Patent Application Publication
(10) Pub. No.: US 2026/0299162 A1
(43) Pub. Date: Oct. 1, 2026

(54) NARROWBAND DIRECTIONAL STABLE THERMAL EMITTERS WITH METAL-BASED THERMAL METASURFACE

(71) Applicant: Vanderbilt University, Nashville, TN (US)

(72) Inventors: Justus C. Ndukaife, Nashville, TN (US); Guodong Zhu, Nashville, TN (US)

(21) Appl. No.: 19/629,739

(22) Filed: Mar. 26, 2026

Related U.S. Application Data
(60) Provisional application No. 63/778,505, filed on Mar. 27, 2025.

(51) Int. Cl. G02B 1/00

(52) U.S. Cl. CPC G02B 1/00

(57) ABSTRACT

A thermal emitter includes a first metal layer, an insulator layer disposed on the first metal layer, and a second metal layer disposed on a surface of the insulator layer opposite the first metal layer, the second metal layer including an array of unit cells. The thermal emitter is configured to emit electromagnetic radiation from the unit cells when the thermal emitter is heated.

### CROSS-REFERENCE TO RELATED APPLICATIONS

This application claims the benefit of U.S. Provisional Application No. 63/778,505 filed Mar. 27, 2025, the entire disclosure of which is incorporated by reference.

### STATEMENT REGARDING FEDERALLY SPONSORED RESEARCH

This invention was made with government support under N000142412085 awarded by the Office of Naval Research. The government has certain rights in the invention.

### FIELD

The present disclosure relates to thermal emitters and, more particularly, to thermal emitters including metal-based metasurfaces.

### SUMMARY

Thermal emitters may include materials or structures that emit electromagnetic radiation when heated. The spectral characteristics of the emission may depend on material properties and design. In various implementations, thermal emitters may be used in applications that rely on controlled electromagnetic radiation emissions, such as controlled infrared radiation. Accordingly, thermal emitters described herein may be utilized in thermal imaging, infrared sensing, and energy harvesting applications. For greenhouse gas detection applications, compact, narrowband thermal emitters may be configured to emit at specific infrared wavelengths absorbed by gases such as CO₂, CH₄, and NOₓ, potentially allowing for real-time monitoring with a small device footprint.

Thermal emitters described in this specification may support industrial and environmental monitoring, including non-contact sensing for leak detection and pollution analysis. In some examples, thermal emitters may be incorporated into thermophotovoltaic (TPV) systems, where thermal radiation may be converted into electricity for energy harvesting applications. Additionally, thermal emitters may be used in radiative cooling, where passive heat dissipation may be facilitated to reduce energy consumption. In various implementations, thermal emitters may be integrated into free-space optical communication systems and may be configured to provide stable, narrowband infrared signals for data transmission. Potential applications may also extend to scientific research and spectroscopy, where precise thermal sources may be desirable for calibration and material analysis.

Thermal emitters described in this specification may include narrowband and directional thermal metasurfaces that, when heated, may generate spatially and temporally coherent photons. In some implementations, a thermal metasurface emitter may be composed of metals such as gold and may be designed to support special states known as Bound States in the Continuum (BIC). By optimizing the design, thermal metasurface emitters may achieve high Q factors for emitted thermal photons. Prior implementations have been limited to Q factors in the range of 10-40; however, thermal metasurfaces described herein may achieve a Q factor exceeding 200. Additionally, thermal metasurface emitters may exhibit resilience against temperature variations, where the emission peak may remain stable even under changing thermal conditions. This stability may support applications where environmental temperatures fluctuate significantly.

Various implementations of thermal metasurface emitters may be considered for applications such as gas sensing and energy harvesting from waste heat. Metal-based thermal metasurfaces may exhibit stable spectral characteristics under temperature fluctuations, in contrast to dielectric counterparts, where emission spectra may shift with changing temperatures. However, conventional metal-based thermal emitters often exhibit limited quality (Q) factors due to significant non-radiative ohmic losses. Thermal emitters described in this specification may address the challenge of achieving high emissivity and high Q factors in metal-based structures. By leveraging the coupling between a bright mode and two BIC resonances to achieve electromagnetically induced absorption (EIA) in an asymmetric metallic ring structure, some implementations may achieve near-unity emissivity (0.96) and a simulated Q factor as high as 320. Experimental validation may yield emissivity of approximately 0.82 and a Q factor of 210, representing an approximately fivefold improvement over state-of-the-art metal-based thermal metasurfaces. These advancements may support the development of efficient, narrowband, directional thermal emitters with stable emission spectra across a wide temperature range.

With respect to various implementations of thermal emitter configurations, thermal emission may be considered one possible approach for generating light at infrared (IR) wavelengths. However, conventional thermal emission may exhibit broadband, omnidirectional, and unpolarized characteristics due to the spontaneous nature of the process. To achieve coherent light emission from thermal radiation, various artificial nanostructures and physical mechanisms may be utilized to tailor the Q factor, polarization, and directionality.

In some implementations, a silicon carbide grating that supports surface phonon polaritons (SPhPs) may be used to produce spatially coherent photons when heated. This effect may result from engineering surface waves, which may lead to coherent emission in the far field. Additionally, in various implementations, thermal emission control may be achieved using metal gratings that support surface plasmon polaritons (SPPs). However, SPPs and SPhPs may experience relatively large propagation losses, which may limit temporal coherence.

To address the challenge of metal ohmic losses in polaritonic structures, various implementations may include alternative materials and configurations that support narrowband resonances. Photonic crystals, metamaterials, metasurfaces, film stacks, superlattices, and bull's eye gratings may be utilized to achieve narrowband emission by leveraging different resonant phenomena, with Q factors typically ranging from approximately 10¹ to 10³. Among these approaches, metallic and dielectric thermal metasurfaces that support bound states in the continuum (BICs) may be particularly promising, as such structures may provide narrowband emission, wavefront engineering capabilities, and adaptable design possibilities.

Originally predicted in early theoretical studies in quantum mechanics, BICs are characterized by theoretically infinite radiation Q factors, which may correspond to vanishing linewidths. In practical implementations, the linewidth of BIC resonances may be finely tuned by breaking symmetry, adjusting the incident angle, and/or modifying metasurface parameters to suit specific application requirements.

Tuning the Q factor may be an important consideration in various implementations of thermal metasurfaces, as near-perfect absorptivity and corresponding emissivity may require a balance between radiative and dissipative losses. This balance may be associated with the coupling condition of the system. Bound states in the continuum (BICs) may be particularly attractive for this purpose due to tunable high-Q properties, which may facilitate tailoring of thermal emission characteristics.

In some implementations, polarization and emission directionality may be controlled using elliptical structures that support a non-local quasi-BIC resonance and local geometric phase. A slotted elliptical metallic thermal metasurface may support a quasi-BIC (QBIC) resonance, which may be capable of emitting narrowband light that remains stable across varying temperatures. Additionally, quasi-BIC dielectric structures may leverage flat-band engineering to enhance the Q factor up to approximately 230. However, in some cases, the emission spectra of such structures may vary with temperature and exhibit reduced spatial coherence. This spectral drift may be attributed to the strong dependence of the refractive index of dielectric materials, such as silicon and germanium, on temperature due to the thermo-optic effect.

Thermal metasurfaces based on metallic structures may offer stable emission spectral performance, as the imaginary part of the refractive index may dominate the optical properties of most metals in the mid- to long-infrared regions. As a result, the penetration depth in metals may be much smaller than the wavelength, and the resonance frequency may be primarily determined by resonator geometry. However, a challenge may remain for metallic structures: achieving narrowband emission with near-unity emissivity may require satisfying specific coupling conditions.

In many designs, a trade-off may be necessary between the Q factor and emissivity, where radiative losses may need to be controlled to balance with non-radiative losses. Additionally, non-radiative losses may be difficult to manage and may be influenced by material properties and fabrication imperfections, which may ultimately limit the achievable Q factor and emissivity in practical applications. Based on reported experimental data, the highest measured Q factor for metal-based thermal emitters to date is approximately 42.

In some aspects, the techniques described herein relate to a thermal emitter, including: a first metal layer; an insulator layer disposed on the first metal layer; and a second metal layer disposed on a surface of the insulator layer opposite the first metal layer, the second metal layer including an array of unit cells; wherein the thermal emitter is configured to emit electromagnetic radiation from the unit cells when the thermal emitter is heated.

In some aspects, the techniques described herein relate to a thermal emitter, wherein the unit cells of the second metal layer are arranged in a substantially regular array of rows and columns.

In some aspects, the techniques described herein relate to a thermal emitter, wherein the unit cells within each row are evenly spaced apart by a center-to-center distance of about 4 micrometers.

In some aspects, the techniques described herein relate to a thermal emitter, wherein the unit cells within each column are evenly spaced apart by a center-to-center distance of about 4 micrometers.

In some aspects, the techniques described herein relate to a thermal emitter, wherein each unit cell includes a first element and a second element.

In some aspects, the techniques described herein relate to a thermal emitter, wherein a periphery of the first element defines a ring and a periphery of the second element defines a ring arc.

In some aspects, the techniques described herein relate to a thermal emitter, wherein the ring and the ring arc are substantially concentric.

In some aspects, the techniques described herein relate to a thermal emitter, wherein each unit cell includes a first element defining a ring and not a second element.

In some aspects, the techniques described herein relate to a thermal emitter, wherein the first metal layer includes a gold material.

In some aspects, the techniques described herein relate to a thermal emitter, wherein the insulator layer includes a dielectric material.

In some aspects, the techniques described herein relate to a thermal emitter, wherein the dielectric material includes an aluminum oxide material.

In some aspects, the techniques described herein relate to a thermal emitter, wherein the dielectric material includes a dysprosium fluoride material.

In some aspects, the techniques described herein relate to a thermal emitter, wherein the second metal layer includes a gold material.

In some aspects, the techniques described herein relate to a thermal emitter, wherein the rows are substantially orthogonal to the columns.

In some aspects, the techniques described herein relate to a thermal emitter, wherein the rows are substantially parallel to a first pair of opposite lateral edges of the first metal layer.

In some aspects, the techniques described herein relate to a thermal emitter, wherein the columns are substantially parallel to a second pair of opposite lateral edges of the first metal layer.

In some aspects, the techniques described herein relate to a thermal emitter, wherein the unit cells are symmetrical about each row.

In some aspects, the techniques described herein relate to a thermal emitter, wherein the unit cells are formed as discrete patterned structures.

In some aspects, the techniques described herein relate to a thermal emitter, including: a first metal layer; and a second metal layer disposed directly on a surface of the first metal layer, the second metal layer including an array of unit cells, wherein no dielectric spacer layer is disposed between the first metal layer and the second metal layer; wherein the thermal emitter is configured to emit electromagnetic radiation from the unit cells when the thermal emitter is heated.

In some aspects, the techniques described herein relate to a thermal emitter, wherein the unit cells of the second metal layer are arranged in a substantially regular array of rows and columns.

Other examples, embodiments, features, and aspects will become apparent by consideration of the detailed description and accompanying drawings.

### BRIEF DESCRIPTION OF THE DRAWINGS

FIG. 1 illustrates a perspective view of a thermal emitter structure, according to some examples.

FIG. 2 illustrates a top view of a unit cell, according to some examples.

FIG. 3 illustrates a partial cross-sectional view of a portion of a thermal emitter structure, according to some examples.

FIG. 4 illustrates a chart and a series of images depicting a simulated emission spectrum for a thermal emitter structure, according to some examples.

FIG. 4A illustrates a schematic of a damped harmonic oscillator model of a coupled bright mode and dark mode within a thermal emitter structure, according to some examples.

FIG. 5 illustrates a series of images and a chart that depict a mode coupling demonstration based on parameter tuning and a band diagram perspective for a thermal emitter structure, according to some examples.

FIG. 6 illustrates a scanning electron microscope (SEM) image of a fabricated sample of thermal emitter structure, along with a series of charts depicting the performance of the fabricated sample, according to some examples.

FIG. 7 illustrates a series of charts depicting polarization-independent emission characteristics of unit cells of a thermal emitter structure, according to some examples.

In the drawings, reference numbers may be reused to identify similar and/or identical elements.

### DETAILED DESCRIPTION

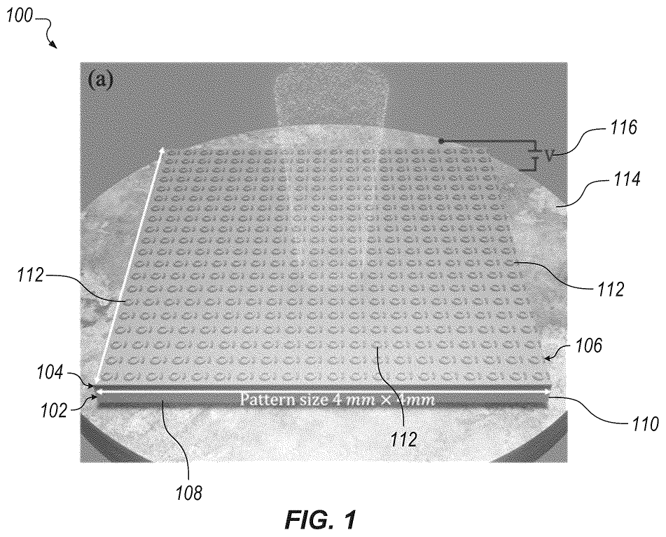

FIG. 1 illustrates a perspective view of a thermal emitter structure 100, according to some examples. In the example shown in FIG. 1, the thermal emitter structure 100 may include a first metal layer 102, an insulator layer 104, and a second metal layer 106. In various implementations, the first metal layer 102 may include a metallic material. The first metal layer 102 may function as a reflective layer configured to prevent optical transmission through the thermal emitter structure 100 and to enhance forward emission from the unit cells 112. The metallic material of the first metal layer 102 may be selected based on reflectivity in a target wavelength range, compatibility with fabrication processes, and thermal stability at intended operating temperatures. In some implementations, the first metal layer 102 may include a gold material. In other implementations, the first metal layer 102 may include a metal having a melting point higher than that of gold to support operation at elevated temperatures. For example, the first metal layer 102 may include tungsten, titanium nitride, zirconium nitride, or tantalum nitride. The selection of a higher-melting-point metal for the first metal layer 102 may extend the operating temperature range of the thermal emitter structure 100 beyond that achievable with gold-based configurations.

In some examples, the insulator layer 104 may include a dielectric material, such as a sapphire material. In various implementations, the insulator layer 104 may include an aluminum oxide material. In some implementations, the insulator layer 104 includes a dysprosium fluoride (DyF3) material.

In some examples, the second metal layer 106 may include a metallic material. The second metal layer 106 may define the resonant structures of the unit cells 112, and the metallic material of the second metal layer 106 may be selected to support the desired resonance characteristics, including quality factor, emissivity, and spectral stability. The metallic material of the second metal layer 106 may also be selected based on compatibility with lithographic patterning processes and thermal stability at intended operating temperatures. In some implementations, the second metal layer 106 may include a gold material. In various implementations, the second metal layer 106 may include a cadmium oxide material. In other implementations, the second metal layer 106 may include a metal having a melting point higher than that of gold to support operation at elevated temperatures. For example, the second metal layer 106 may include tungsten, titanium nitride, zirconium nitride, or tantalum nitride. The use of a higher-melting-point metal for the second metal layer 106 may enable the thermal emitter structure 100 to maintain structural and spectral integrity at temperatures that would exceed the thermal limits of gold-based structures.

The insulator layer 104 may be positioned between the first metal layer 102 and the second metal layer 106, forming a metal-insulator-metal (MIM) configuration. In various implementations, the insulator layer 104 is disposed on the first metal layer 102, and the second metal layer 106 is disposed on a surface of the insulator layer 104 opposite the first metal layer 102. In some configurations, the insulator layer 104 may be directly in contact with the first metal layer 102, while in other configurations one or more intermediate layers, such as adhesion layers or interface layers, may be positioned between the insulator layer 104 and the first metal layer 102. Similarly, the second metal layer 106 may be formed on an opposing surface of the insulator layer 104, either in direct contact with the insulator layer 104 or with one or more intervening layers, while maintaining the stacked arrangement of the metal-insulator-metal configuration.

In alternative implementations, the insulator layer 104 may be omitted such that the unit cells 112 of the second metal layer 106 are disposed directly on the first metal layer 102 without a dielectric spacer layer in-between. In such spacerless configurations, the unit cells 112 may be formed on a surface of the first metal layer 102, and the thermal emitter structure 100 may lack a distinct insulator layer separating the patterned unit cells 112 from the underlying reflective metal. The first metal layer 102 may function as both a substrate and a reflector, and the unit cells 112 may be patterned directly thereon using lithographic techniques such as electron beam lithography, photolithography, or nanoimprint lithography.

In various implementations of the spacerless configuration, the periodic arrangement of the unit cells 112 may still support surface lattice resonances (SLRs) and associated bound states in the continuum (BICs), because these resonances may arise primarily from the periodic lattice arrangement and the geometry of the unit cells 112 rather than from the presence of a dielectric spacer. However, the coupling conditions between the resonances may differ from those of the metal-insulator-metal (MIM) configuration. In the MIM configuration, the insulator layer 104 may facilitate tuning of the resonance coupling by controlling the optical path length and near-field interaction between the patterned unit cells 112 and the first metal layer 102. In the spacerless configuration, the coupling conditions may instead be governed primarily by the geometry and dimensions of the unit cells 112, the periodicity of the array, and the material properties of the first metal layer 102. As a result, the balance between radiative and non-radiative losses may differ, and the Q factor and emissivity characteristics may be adjusted by modifying the unit cell geometry, array pitch, and structure height rather than the spacer thickness. In some examples, the spacerless configuration may simplify the fabrication process by eliminating one or more deposition steps and may reduce the overall thickness of the thermal emitter structure 100.

The first metal layer 102 may be formed as a substantially planar layer with a defined thickness and a periphery 108. In some implementations, the periphery 108 of the first metal layer 102 may define a substantially square shape. In some examples, the edges of the periphery 108 may have a length of approximately 4 mm. The insulator layer 104 may also be formed as a substantially planar layer with a periphery 110 that defines a substantially square shape. In various implementations, the edges of the periphery 110 may have a length of approximately 4 mm. In some examples, the first metal layer 102 and the insulator layer 104 may be aligned so that the periphery 108 is coextensive with the periphery 110.

The second metal layer 106 may be formed as an array of unit cells 112 rather than a continuous planar layer. In various implementations, the unit cells 112 are formed as discrete patterned structures, such that the second metal layer 106 is defined by spatially separated or individually defined features rather than a continuous film. Discrete patterned structures may refer to structural elements that are lithographically defined, etched, deposited, or otherwise fabricated as distinguishable units having boundaries, gaps, or separations between adjacent structures. For example, discrete patterned structures may include periodic or aperiodic arrays of rings, ring segments, arcs, split-ring resonators, pillars, islands, patches, or other geometrically defined metallic features arranged on the insulator layer 104. In some implementations, the discrete patterned structures may be separated by void regions, dielectric regions, or non-emissive portions of the substrate, thereby enabling localized resonant behavior within each unit cell.

In various implementations, the unit cells 112 may be arranged in a substantially regular array. In various implementations, the unit cells 112 may be organized into an array of evenly spaced rows and columns. The rows may be substantially aligned or parallel to a first pair of opposite lateral edges of the periphery 108 and the periphery 110, while the columns may be substantially aligned or parallel to a second pair of opposite lateral edges of the periphery 108 and the periphery 110. The rows and columns may be arranged substantially orthogonally.

Within each column, the unit cells 112 may be aligned so that their centers are evenly spaced apart. In various implementations, the center-to-center distance between adjacent unit cells 112 within a column may be approximately 4 micrometers (μm). Within each row, the unit cells 112 may also be aligned so that their centers are evenly spaced apart. In some examples, the center-to-center distance between adjacent unit cells 112 within a row may be approximately 4 μm. Accordingly, the unit cells 112 may be arranged in rows and columns to form a rectangular or square array.

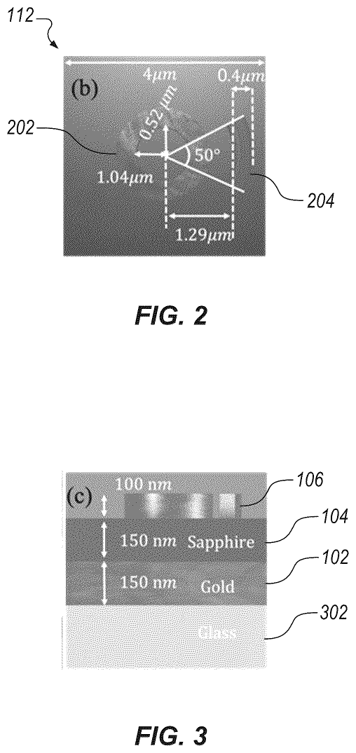

FIG. 2 illustrates a top view of a unit cell 112, according to some examples. Each unit cell 112 may include a first element, such as a first emitter 202 and a second element, such as a second emitter 204. The first emitter 202 and the second emitter 204 may have substantially planar top and bottom surfaces that are parallel to the top and bottom surfaces of the first metal layer 102 and the insulator layer 104. The periphery of the first emitter 202, as defined in the plane of the top and bottom surfaces of the unit cell 112, may form a ring having an inner radius and an outer radius. In some examples, the inner radius may be approximately 0.52 μm. In various implementations, the outer radius may be approximately 1.04 μm.

The periphery of the second emitter 204, as defined in the plane of the top and bottom surfaces of the unit cell 112, may form a portion of a ring, such as a segmented ring or a ring arc. In various implementations, the periphery of the second emitter 204 may be concentric with, or share a center point with, the periphery of the first emitter 202. In some examples, the periphery of the second emitter 204 may have an inner radius of approximately 1.29 μm and an outer radius of approximately 1.69 μm, corresponding to a thickness of approximately 0.4 μm. In various implementations, the axis of symmetry or central axis of the second emitter 204 may be parallel to or coincident with each row, such that each unit cell 112 may be symmetrical about each row. In some implementations, the second emitter 204 may subtend an angular span of approximately 50 degrees as measured about the center of the first emitter 202. The angular span of the second emitter 204 may be selected to differentiate the spectral responses of the unit cell 112 to X-polarized and Y-polarized incident or emitted radiation.

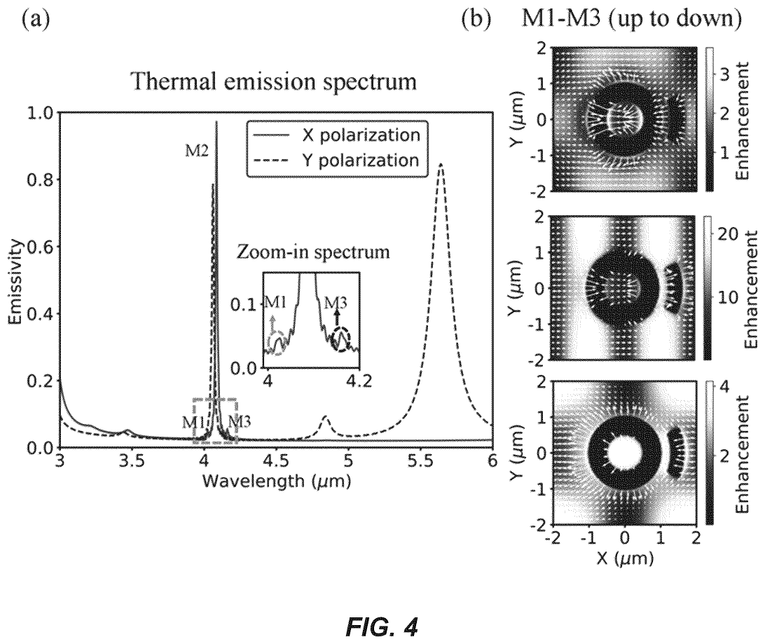

FIG. 3 illustrates a partial cross-sectional view of a portion of the thermal emitter structure 100, according to some examples. In various implementations, the thermal emitter structure 100 may be positioned on a glass layer 302, with the bottom surface of the first metal layer 102 in contact with the glass layer 302. As illustrated in FIG. 3, some examples of the first metal layer 102 may have a thickness of approximately 150 nanometers (nm). In various implementations, the insulator layer 104 may have a thickness of approximately 150 nm. In some examples, the second metal layer 106 may have a thickness of approximately 100 nm.

Returning to FIG. 1, the thermal emitter structure 100 may be heated by a heating element 114 such that the thermal emitter structure 100 reaches a temperature sufficient to emit electromagnetic radiation. As described herein, heating the thermal emitter structure 100 may induce thermal excitation within the metal-insulator-metal (MIM) configuration, leading to electromagnetic radiation emission at specific wavelengths. The spectral characteristics of the emitted radiation may depend on the structural design, material composition, and resonance properties of the thermal emitter structure 100.

In various implementations, the thermal emitter structure 100 may be positioned on the heating element 114 such that the bottom surface of the first metal layer 102 is in contact with the heating element 114. In some examples, the heating element 114 may be a resistive heating element electrically coupled to a voltage source 116. The voltage source 116 may be configured to provide an electrical current to the heating element 114, resulting in Joule heating. In various implementations, the heating element 114 may include a thin-film resistive heater, a ceramic-based heater, or a microfabricated heating substrate. In some examples, the heating element 114 may comprise a thermoelectric heating system, where heat generation may be controlled by an applied electrical potential. In various implementations, alternative heating mechanisms may include optical heating using an external infrared laser or convective heating via a controlled thermal environment.

Various implementations of thermal emitters, such as thermal emitter structure 100, may utilize multiple coupled resonances to achieve near-unity emissivity and a high Q factor. In some examples, precise tuning of the coupling between two bound states in the continuum (BIC) resonances and a bright mode may allow metallic metasurface structures, such as thermal emitter structure 100, to achieve a Q factor of approximately 320 and near-unity emissivity of approximately 0.96 simultaneously. This enhancement may be attributed to the classical analog of electromagnetically induced absorption (EIA).

In quantum systems, EIA may arise from constructive quantum interference of excitation probabilities at different energy levels, leading to enhanced absorption. This phenomenon may serve as a complementary process to electromagnetically induced transparency (EIT). The classical analogs of EIT and EIA have been studied for their unique properties, such as slow light propagation and high transmission or absorption.

With respect to physical implementation, various thermal emitters, such as thermal emitter structure 100, may include a metal-insulator-metal (MIM) configuration to prevent optical transmission through the structure. In some implementations, an aluminum oxide spacer within thermal emitter structure 100 may provide a means for tuning the coupling of resonances. Further details regarding specific structural configurations of thermal emitter structure 100 may be described with reference to FIGS. 1-3.

FIG. 1 illustrates an example of thermal emitter structure 100, in which a periodic pattern measuring approximately 4 mm by 4 mm may be formed on a heating element. In various implementations, this periodic pattern may correspond to an array of unit cells, as described with reference to FIG. 2. FIG. 2 provides a top view of a unit cell 112 within thermal emitter structure 100, where a complete circular gold ring and a segmented gold ring may form a resonant structure configured to support near-unity emission with a Q factor of up to approximately 320 at a wavelength of 4 μm.

FIG. 3 illustrates a side view of unit cell 112 within thermal emitter structure 100. In some implementations, a gold reflector may be positioned at the back of the structure to enhance forward emission. Additionally, a sapphire spacer may be incorporated within thermal emitter structure 100 to facilitate tuning of the coupling between the three resonances. This configuration may support precise control over the spectral characteristics of the emitted radiation, contributing to high-Q, narrowband thermal emission.

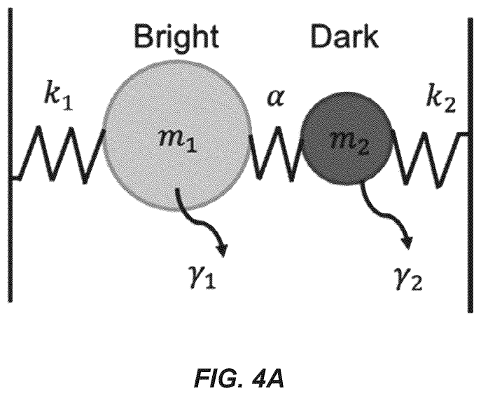

FIG. 4 illustrates a chart and a series of images depicting a simulated emission spectrum for thermal emitter structure 100, according to some examples. The simulated emission spectrum demonstrates a high Q factor and near-unity emissivity, with an electric field distribution corresponding to three coupled resonance modes.

FIG. 4 (at a) illustrates the emission spectrum for X- and Y-polarized light. The spectrum for X-polarized light exhibits three resonances around a wavelength of approximately 4 μm. Resonance Mode 1 (M1) and Mode 3 (M3) correspond to bound states in the continuum (BICs), which appear as weak peaks, while Mode 2 (M2) is a resonance mode at the center of the spectrum with strong absorptance. In various implementations, tuning the coupling between these three modes within thermal emitter structure 100 may facilitate the achievement of a high Q factor and near-unity emissivity. The inset of FIG. 4 (at a) provides a magnified view of the X-polarized spectrum.

FIG. 4 (at b) illustrates the electric field distribution associated with the three resonant modes in thermal emitter structure 100. Mode 1 (M1) may be a dual-quasi-BIC mode, formed through the combination of a symmetry-protected BIC (SP-BIC) and a Friedrich-Wintgen BIC (FW-BIC). This mode, in principle, exhibits an infinite Q factor.

FIG. 4A illustrates a schematic of a damped harmonic oscillator model representing the coupling between a bright mode and a dark mode within thermal emitter structure 100, according to some examples. In this model, the bright mode may be directly excited by external radiation with an associated damping rate γ₁, while the dark mode may not be directly excited by external radiation and may have a damping rate 72 that is typically much smaller than γ₁. The bright mode and the dark mode may be coupled through a coupling parameter α. The bright mode may correspond to the standing wave formed by the degenerate SLR (±1, 0) modes, and the dark mode may correspond to SLR (0, ±1). Through their mutual coupling, the bright mode may acquire additional non-radiative damping from the dark mode, which may drive the system toward a condition in which the radiative damping rate equals the total non-radiative damping rate. This additional non-radiative loss channel arising from coupling may be consistent with the electromagnetically induced absorption (EIA) mechanism described herein.

According to Kirchhoff's Law, achieving a perfect thermal emitter within thermal emitter structure 100 may be equivalent to designing a perfect absorber. Conventional approaches for achieving perfect absorption often require precise balancing of non-radiative loss (γₐ) and radiative loss (γᵣ), which may be governed by the critical coupling condition (γᵣ=γₐ). Based on mathematical derivations from temporal coupled mode theory (TCMT), described in the Materials and Methods section, the total Q factor (Qₜₒₜ) may be determined by both radiative Q factor (Qᵣ) and non-radiative Q factor (Qₐ) as follows in Equation (1):

$$\frac{1}{{Q}_{tot}} = \frac{1}{{Q}_{r}} + \frac{1}{{Q}_{a}} \qquad ( 1 )$$

In practical implementations of thermal emitter structure 100, estimating dissipative losses may present challenges, as factors such as fabrication imperfections, intrinsic material loss, surface roughness, and resonance modal profiles may influence overall performance. Under such conditions, selecting a mode with a relatively large γᵣ may be necessary to compensate for dissipative loss, which may result in a trade-off between achieving a high Q factor and maintaining near-unity emissivity. As a result, high-Q thermal metasurfaces with high emissivity are seldom demonstrated experimentally in metal-based structures due to significant ohmic loss.

In various implementations, an ultra-narrowband thermal emission spectrum centered near a mid-infrared wavelength of approximately 4 μm may be achieved within thermal emitter structure 100 by carefully engineering the coupling between three resonances. Numerical simulations indicate that this approach may result in a Q factor of approximately 320 and a near-unity emissivity of approximately 0.96 for X-polarized light, as illustrated in FIG. 4 (at a). The coupled resonance position may be tunable by adjusting the periodicity and radius of the metasurface ring elements while maintaining high Q factors and emissivity.

In various implementations, the periodic arrangement of the unit cells 112 within thermal emitter structure 100 may support three surface lattice resonances (SLRs). The dispersion of two of the SLRs may follow the Rayleigh Anomaly of orders (±1, 0), while the dispersion of a third, degenerate SLR may follow the Rayleigh Anomaly of orders (0, ±1). For clarity, when these three resonances are not coupled, they may be denoted as SLR (1, 0), SLR (−1, 0), and SLR (0, ±1) to reflect their correspondence to the associated Rayleigh Anomaly orders. Under TM polarization incidence (X polarization), SLR (±1, 0) may be bright modes and SLR (0, ±1) may be a dark mode. The intrinsically low-loss nature of surface lattice resonances, wherein the lattice effect may suppress both radiative and non-radiative loss, may contribute to the high Q factor performance of thermal emitter structure 100.

Because SLR (1, 0) and SLR (−1, 0) are counter-propagating surface waves that become degenerate at the Γ point, a standing wave along the X direction may be formed in the vicinity of the Γ point. When strongly coupled, the three SLRs may be denoted as Mode 1 (M1), Mode 3 (M3), and Mode 2 (M2), corresponding to SLR (1, 0), SLR (−1, 0), and SLR (0, ±1), respectively. In some implementations, the dominant resonance M2 may be a hybrid mode resulting from the coupling of the standing wave of SLR (1, 0) and SLR (−1, 0) with SLR (0, ±1). The electric field distribution of M2 may exhibit a standing-wave-like pattern in the X direction.

In various implementations, M1 may exhibit C2 rotational symmetry and M3 may exhibit C4 rotational symmetry, as observed in their respective electric field distributions. These symmetries may be incompatible with free-space propagating waves, such that M1 and M3 may become non-radiative modes or bound states in the continuum (BICs) at the Γ point. In the absence of coupling, the BICs may remain close to the standing wave with a slight frequency difference. However, when the standing wave is coupled to SLR (0, ±1), a wider band gap may open between the BICs and the standing wave, confining the two BICs (M1 and M3) around the standing wave (M2) near the Γ point. This confinement may enable a single emission peak from the three-resonance condition along the normal direction and may enhance the Q factor of M2 from approximately 53 in its intrinsic uncoupled state to approximately 320 under strong coupling conditions.

Within thermal emitter structure 100, Resonance 1 (M1) and Resonance 3 (M3) may correspond to BIC resonances, which are considered dark states with theoretically infinite Q factors. In some implementations, Resonance 1 (M1) may exhibit dual-quasi-BIC behavior, combining characteristics of both symmetry-protected BIC (SP-BIC) and Friedrich-Wintgen BIC (FW-BIC). Since M1 and M3 are weakly coupled to free-space radiation, their spectral peaks may appear as lower-amplitude features flanking Resonance 2 (M2) in FIG. 4 (at a).

Analysis via multipolar decomposition indicates that Resonance 2 (M2) is primarily governed by a magnetic dipole mode. Due to this dipole nature, M2 may act as a bright state, facilitating stronger coupling to free-space radiation. The electric field distribution associated with the three resonances within thermal emitter structure 100 is depicted in FIG. 4 (at b). The strong absorptance peak observed for M2 in FIG. 4 (at a) may result from the optimal coupling between the two BICs (M1 and M3) and the magnetic dipole bright mode (M2).

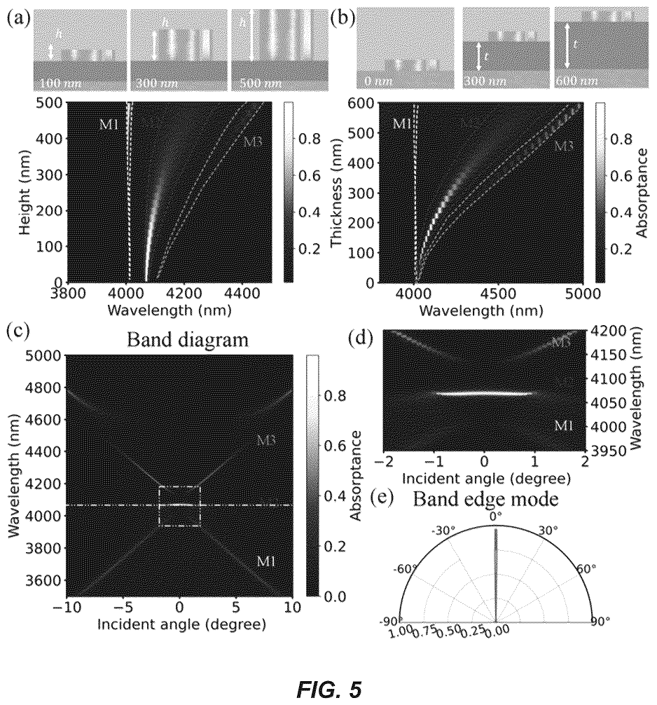

FIG. 5 illustrates a series of images and a chart that depict a mode coupling demonstration based on parameter tuning and a band diagram perspective for the thermal emitter structure 100, according to some examples. FIG. 5 (at a) illustrates the absorbance of thermal emitter structure 100 as a function of pillar height, while maintaining a fixed spacer layer thickness of approximately 150 nm. FIG. 5 (at b) illustrates the absorbance of thermal emitter structure 100 as a function of spacer layer thickness, with a fixed pillar height of approximately 100 nm. In various implementations, the absorbance of thermal emitter structure 100 may increase with adjustments to the spacer layer thickness, reaching approximately 0.9 when the spacer layer is 150 nm thick. The absorptance and Q factor associated with thermal emitter structure 100 may be tunable by adjusting the spacer layer thickness and pillar height.

When the three resonances within thermal emitter structure 100 are in close proximity, strong coupling between the modes may enhance both the Q factor and the absorbance. FIG. 5 (at c) illustrates the band structure of the three modes in momentum space. In some implementations, Mode 1 (M1), Mode 2 (M2), and Mode 3 (M3) may exhibit strong coupling near the Γ point (within 1°), significantly enhancing the absorptance of Mode 2 up to approximately 0.9.

As shown in FIG. 5 (at c), the coupling between the standing wave and SLR (0, ±1) may open a wider band gap between the BICs and the standing wave compared to the uncoupled scenario. This band gap widening may confine both BICs (M1 and M3) in the vicinity of the Γ point, ensuring that only a single emission peak associated with M2 is observed along the normal direction within the angular range of strong coupling. The high-Q characteristics inherent to the BIC modes may thereby be transferred to the coupled standing wave mode M2, contributing to the record Q factor performance of thermal emitter structure 100.

FIG. 5 (at d) presents a magnified view of the region marked by the white box in FIG. 5 (at a), highlighting the fine details of the parameter-dependent absorptance variations in thermal emitter structure 100. FIG. 5 (at e) illustrates a polar diagram of the band-edge mode (marked by a white line in FIG. 5 (at a)), further confirming the directionality characteristics of thermal emitter structure 100.

To numerically demonstrate how the Q factor and emissivity may be enhanced through the coupling of two bound states in the continuum (BIC) resonances with a bright mode, parameter sweep diagrams may be constructed by adjusting the spacer layer thickness and gold ring height, as depicted in FIG. 5 (at a-b). In some implementations, the spacer layer thickness may be fixed at approximately 150 nm, while the height of the gold ring structure in thermal emitter structure 100 may be varied from approximately 500 nm to 50 nm in steps of 10 nm. The results shown in FIG. 5 (at a) illustrate that as the frequency of Mode 1 (M1) and Mode 3 (M3) approaches the frequency of Mode 2 (M2), the absorptance of Mode 2 may increase while the linewidth of Mode 2 may become narrow.

In some implementations, the gold ring structure in thermal emitter structure 100 may have a fixed height of approximately 100 nm, while the thickness of the spacer layer may be varied from approximately 600 nm to 0 nm. As depicted in FIG. 5 (at b), similar trends may be observed, where the Q factor and emissivity of thermal emitter structure 100 may increase as the three resonances become coupled. This enhancement may be attributed to a classical analog of electromagnetically induced absorption (EIA), where the constructive interference of the three resonances, including two BICs and a bright mode (a magnetic dipole), may enhance absorption and the Q factor. In various implementations, the strong coupling between the three resonances may confine the two BICs (M1 and M3) around the standing wave (M2) near the Γ point. This confinement may not only enable a single emission peak from the three-resonance condition along the normal direction, but may also enhance the Q factor of M2 from approximately 53 in its intrinsic uncoupled state to approximately 320 under strong-coupling conditions, representing an approximately sixfold improvement attributable to the coupling mechanism.

To further explain the three-resonance coupling mechanism in thermal emitter structure 100, three pathways may be considered within the system. The first pathway may represent a direct transition in which free-space light (ground state, M0) may directly couple to Mode 2 (M2) through the transition M0→M2. The second and third pathways may be indirect transitions, where M1 and M3 are weakly coupled to free space and Mode 2 plays an intermediate role, represented as M0→M2→M1(3)→M2. In these indirect pathways, the excitation of M1 (or M3) and the back-action excitation of M2 may be facilitated by near-field coupling between M2 and M1 (or M3) through a coupling parameter α. The constructive interference between these three pathways may significantly enhance the absorption and Q factor of M2 near the resonance frequency, which may be achieved by tuning the coupling between the resonances.

To mathematically describe this phenomenon, temporal coupled mode theory (TCMT) may be applied to derive an absorption expression under the three-resonance coupling scenario, as discussed in the Materials and Methods section. The absorption expression suggests that near-unity absorption may be achieved by tuning the coupling parameters α₁₂ and α₂₃. Additional details regarding the mathematical derivation and analysis may be found in the Materials and Methods section.

To further examine the coupling between the three resonances and the enhancement of absorption, a band diagram of the three resonances in momentum space may be plotted, as illustrated in FIG. 5 (at c). In some implementations, Mode 1 (M1), Mode 2 (M2), and Mode 3 (M3) within thermal emitter structure 100 may exhibit coupling near the Γ point (within approximately 1°), leading to a significant increase in absorptance of the coupled resonances. Outside this angular range, the absorptance may decrease substantially.

Due to reciprocity, this behavior may indicate that thermal emitter structure 100 exhibits strong directionality and spatial coherence. As shown in FIG. 5 (at e), the polar diagram of the band-edge mode (marked by the white line in FIG. 5 (at c)) may further support this observation, demonstrating the angular dependence of the emission characteristics. This directionality may contribute to applications where controlled thermal radiation emission patterns are desirable.

For Y-polarized emission, the spectrum of thermal emitter structure 100 may exhibit a blue shift of approximately 25 nm and a slight reduction in emissivity compared with the X-polarized emission when the second emitter 204 (the segmented ring structure) is present. In some implementations, this dual-polarization behavior may offer a practical advantage for gas sensing applications. Without polarizing filters, the emission spectrum of thermal emitter structure 100 may naturally feature two peaks corresponding to X-polarized and Y-polarized emissions. One of the emission peaks may serve as a reference peak to examine environmental absorptions, which may improve the accuracy of gas detection. The blue shift of Y-polarized emission toward X-polarized emission may be tuned from approximately 0 nm to approximately 30 nm by adjusting the parameters of the second emitter 204.

For gas molecules such as methane, which may exhibit sharp absorption bands in the mid-infrared, this tunability may afford flexibility to meet specific application requirements. In various implementations, the emission wavelength of thermal emitter structure 100 may be aligned with a target absorption band of a gas of interest, such as CO₂, CH₄, or NOₓ, while the reference peak from the orthogonal polarization may be positioned at a nearby wavelength that is not absorbed by the target gas, thereby enabling differential detection.

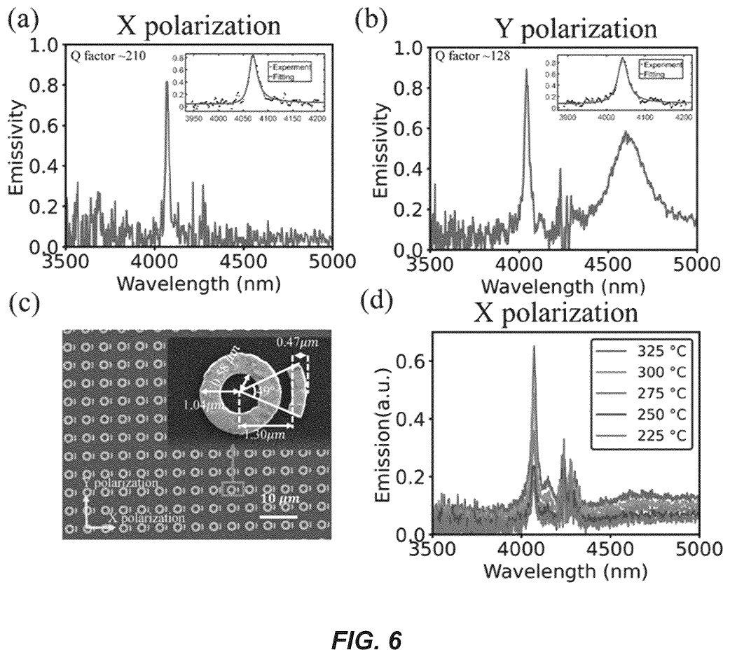

FIG. 6 illustrates a scanning electron microscope (SEM) image of a fabricated sample of thermal emitter structure 100, along with a series of charts depicting the performance of the fabricated sample, according to some examples. FIG. 6 (at a) shows SEM images of the fabricated sample, which may have dimensions of approximately 4 mm×4 mm.

FIG. 6 (at b and c) illustrate the thermal emission spectrum measured at normal incidence when the fabricated sample is heated to approximately 300° C. In some implementations, the fabricated sample of thermal emitter structure 100 may exhibit a single ultra-high-Q resonance with a peak emissivity of approximately 0.82 for X-polarized light. The measured Y-polarization emission spectrum may align with numerical simulations, displaying a sharp peak and a broader peak within the relevant wavelength range.

FIG. 6 (at d) depicts the emission spectrum of the fabricated sample at various temperatures. In some examples, the center wavelength of the emission spectrum may exhibit minimal spectral shift, suggesting that thermal emitter structure 100 may exhibit temperature-insensitive performance. Additionally, as the sample temperature decreases, the overall emission intensity may decrease, consistent with thermal radiation behavior.

To assess the theoretical model and structural design, a fabricated sample of thermal emitter structure 100 was experimentally characterized. In some implementations, the fabricated sample may span an area of approximately 4 mm×4 mm, incorporating approximately one million unit cells. The fabrication process may involve deposition on a glass substrate, which may include a 150 nm gold reflecting layer and an aluminum oxide spacer layer. In various implementations, the patterning of the structure may be achieved using electron beam lithography and physical vapor deposition. FIG. 6 (at c) illustrates a scanning electron microscopy (SEM) image of a fabricated sample of thermal emitter structure 100.

The emission spectrum of the fabricated sample may be measured using a Fourier transform infrared (FTIR) spectrometer, which may be equipped with a mercury cadmium telluride (MCT) detector. In some examples, the fabricated sample may be heated to approximately 300° C., and the corresponding thermal emission signals may be acquired. The emissivity may be obtained by normalizing the measured emission to the emission of a reference black body, such as a vertically aligned carbon nanotube (VACNT) emitter, measured under the same conditions and at the same temperature. The results, depicted in FIG. 6 (at a), indicate that thermal emitter structure 100 may exhibit a single resonance with a high Q factor of approximately 210 and a peak emissivity of approximately 0.82 for X-polarized light. The Q factor may be determined using the overall damping rate and resonance frequency, which may be obtained from spectral fitting using the “CFTool” toolbox in MATLAB (see details in the Materials and Methods section).

Comparisons between measured and simulated spectra, as shown in FIG. 6 (at a), may demonstrate strong agreement in spectral features. For Y-polarization measurements, experimental results may also align with simulations, displaying both a sharp peak and a broad peak within the wavelength range of interest, as depicted in FIG. 6 (at b). The increased noise observed near 4300 nm may be attributed to carbon dioxide absorption.

The experimentally measured Q factor of 210 and emissivity of 0.82 may differ from simulated values of 320 and 0.96, respectively. This discrepancy may arise due to several factors, including fabrication imperfections such as surface roughness and stitching errors associated with electron beam lithography, as well as the finite sample size used in the experimental setup. Additionally, differences in illumination conditions may contribute to variations between experimental and simulated results. While simulations may assume normal incident illumination, experimental measurements may involve photon collection within an angular range of approximately 1° using a custom-built setup.

The dispersive nature of the band structure, as shown in FIG. 6 (at c), suggests that off-normal photon collection may influence experimental results. In various implementations, enhancing the performance of thermal emitter structure 100 may involve fabricating larger samples with an increased number of unit cells, optimizing gold deposition techniques, and refining the experimental setup to minimize the photon collection angle.

Thermal emitters described herein may exhibit spectral emission characteristics that remain stable under temperature fluctuations. To assess the robustness of the emission spectrum under varying thermal conditions, the fabricated sample of thermal emitter structure 100 may be heated to temperatures ranging from 225° C. to 325° C., and the corresponding thermal emission spectrum may be collected. As depicted in FIG. 6 (at d), the resonance wavelength may exhibit minimal spectral shift across a 100° C. temperature variation range, suggesting that thermal emitter structure 100 may exhibit temperature-insensitive emission behavior.

This temperature stability may provide an advantage over dielectric-based thermal metasurfaces, which may experience emission spectrum shifts due to temperature-induced changes in refractive index. In contrast, metal-based thermal metasurfaces, such as thermal emitter structure 100, may maintain spectral stability due to geometric and material properties that limit the influence of temperature fluctuations on resonance conditions.

In various implementations, thermal emitter structure 100 may integrate multiple coupled resonances to achieve desirable performance characteristics, including a high Q factor, near-unity emissivity, and robust spectral stability over a range of operating temperatures. This combination of properties may not have been demonstrated in previous thermal emitter designs. A comparative analysis with prior thermal emitter implementations based on different mechanisms may be provided in Table 1 below, highlighting potential performance advantages of thermal emitter structure 100 (implemented as “EIA with BICs” in the example of Table 1).

TABLE 1
Comparison Between Different Experimentally
Measured Thermal Emitters

| | | | | Resilience | |
|---|---|---|---|---|---|
| | | | | Against | |
| | Temper- | Q | | Temperature | Spectrum |
| Mechanism | ature (K) | Factor | Emissivity | Variations | Tunability |
| SPhP | 728 | 27 | 0.85 | No | Low |
| SPP | 573 | 16 | ~1 | No | High |
| TPP | 543 | 36 | 0.75 | No | Low |
| BIC | 573 | 42 | 0.56 | Yes | High |
| Band | 549 | 224 | 0.5 | No | High |
| Folding | | | | | |
| EIA | 573 | 210 | 0.8 | Yes | High |
| with BICs | | | | | |

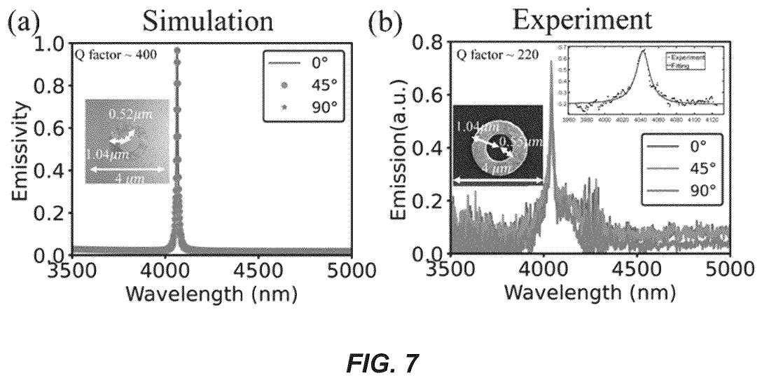

FIG. 7 illustrates a series of charts depicting polarization-independent emission characteristics of the unit cells 112 of the thermal emitter structure 100, according to some examples. In some implementations, a symmetric ring structure may be incorporated within the unit cells 112 to support polarization-independent emission. The symmetric ring structure of the unit cells 112 may maintain a high Q factor and emissivity, which may be facilitated by electromagnetically induced absorption (EIA). FIG. 7 (at a) presents simulation results for three different polarization conditions, while FIG. 7 (at b) illustrates corresponding experimental measurements under the same polarization conditions. In various implementations, the simulated and experimentally measured results may demonstrate strong agreement, suggesting that the structural design of thermal emitter structure 100 may support polarization-independent emission performance.

In various implementations, high-Q factor and near-unity emissivity may be achieved in metal-based thermal emitters, such as thermal emitter structure 100, by leveraging the coupling between two bound states in the continuum (BIC) resonances and a bright mode. This effect may be attributed to a classical analog of electromagnetically induced absorption (EIA), which may facilitate strong light-matter interactions, enhancing both absorptance and the Q factor.

From a theoretical perspective, the dual-BIC resonance M1 and the single-BIC resonance M3 may exhibit high Q factors, making direct excitation from free space challenging. As a result, the absorption or emissivity of these resonances may be relatively low. However, in some implementations, the presence of a bright mode M2 may allow indirect excitation of M1 and M3 through near-field coupling. Additionally, due to reciprocity, M1 and M3 may induce back-action excitation of M2. The interaction between these pathways may give rise to three possible excitation mechanisms for M2: (1) direct free-space excitation (M0→M2); (2) indirect excitation through M1 (M0→M2→M1→M2); and (3) indirect excitation through M3 (M0→M2→M3→M2). The constructive interference between these excitation pathways, particularly near the IΓ point in momentum space, may significantly enhance the absorptance of M2.

Experimental validation of thermal emitter structure 100 aligns with these theoretical predictions, demonstrating a single ultra-high-Q resonance (up to approximately 210) and a peak emissivity of approximately 0.82 for X-polarized light when heated to approximately 300° C. Additionally, experimental results may indicate that the thermal emission spectrum of thermal emitter structure 100 remains stable over a wide temperature range, in contrast to previously reported dielectric thermal emitters, which may experience spectral shifts due to thermo-optic effects.

Further refinements to the thermal metasurface design may support polarization-independent emission characteristics. In some implementations, a symmetric ring structure, such as that depicted in FIG. 7 (at a), may be introduced within the unit cells 112 of thermal emitter structure 100. The simulation results may indicate that EIA may still occur after removing the segmented ring, leading to an increase in Q factor and absorptance. However, in this configuration, the two BIC resonances may become entirely dark states, making them no longer visible in the emission spectrum. Fabrication and experimental measurement of this modified design demonstrate strong agreement with numerical simulations, as shown in FIG. 7.

Various implementations of thermal emitter structure 100 may support applications that rely on narrowband thermal emission, such as free-space optical communication, molecular sensing, medical diagnostics, environmental monitoring, and thermal management. The ability to achieve high Q factors and near-unity emissivity through resonance coupling in a metal-based metasurface may provide new possibilities for designing efficient metal-insulator-metal (MIM) thermal emitters with tailored spectral and directional properties. Additionally, the tunability of polarization, chirality, and emission directionality may be controlled by precisely controlling the phase of the coupled resonances.

### Materials and Methods

### 1. Materials and Fabrication

In various implementations, thermal metasurfaces, such as thermal emitter structure 100, may be fabricated using a standard nanostructure fabrication process in a cleanroom environment. The fabrication process may begin with the deposition of a chromium adhesion layer on a clean glass substrate. A gold reflective layer may then be deposited, followed by an aluminum oxide spacer layer. The gold ring structures positioned above the spacer layer may be patterned using electron beam lithography (EBL) with a positive photoresist, such as polymethyl methacrylate (PMMA). In some implementations, a thin titanium adhesion layer may be deposited to enhance the structural integrity of the gold ring structures and prevent delamination from the spacer layer.

### 2. Simulations

In various implementations, spectral characteristics of thermal emitter structure 100 may be analyzed using numerical simulations. Full-wave finite-difference time-domain (FDTD) simulations may be performed using Ansys Lumerical FDTD 2024, while band structure calculations may be conducted using a finite-element-frequency-domain solver with a tetrahedral mesh, such as CST Studio Suite 2024. Simulation results obtained from both software platforms may demonstrate strong agreement.

In some implementations, additional numerical simulations may be performed using Tidy3D FDTD. For simulations in Tidy3D FDTD, periodic boundary conditions may be applied in both X and Y directions, and perfectly matched layer (PML) boundary conditions may be applied along the Z direction. In some examples, 64 layers may be used for the upper PML to achieve improved absorption at the boundary. Override mesh regions may enclose the resonators, spacer layer, and reflector layer with a maximum mesh step of approximately 10 nm in the X, Y, and Z directions. Simulation results obtained from Tidy3D FDTD may be compared with those from Ansys Lumerical FDTD and CST Studio Suite to ensure consistency across multiple simulation platforms.

Material properties used in the simulations may be sourced from established datasets. In some examples, the optical properties of gold may be obtained from Olmon et al., while the refractive indices of glass and aluminum oxide may be directly sourced from the Lumerical materials database. The refractive index value of the aluminum oxide (Al₂O₃) spacer layer may be set to approximately 1.685, which may be consistent with values reported in the Handbook of Optical Constants of Solids. The refractive index of the glass (SiO₂) substrate may be set to approximately 1.46. In various implementations, the simulation environment may be modeled as air with a refractive index of 1.0.

The simulation environment may be modeled as air, with specific boundary conditions applied. For Lumerical FDTD simulations, periodic boundary conditions may be applied in the lateral directions, while open boundary conditions may be implemented in the vertical direction. The gold structures within thermal emitter structure 100 may be meshed with a maximum step size of approximately 20 nm in all directions to ensure accuracy.

For CST simulations, wave port excitation boundaries may be utilized to excite the resonance modes of thermal emitter structure 100. In some implementations, the number of Floquet modes may be set to 10 to minimize artificial spectral peaks. Additionally, automatic mesh refinement may be applied to improve the accuracy of the simulation results.

### 3. Temporal Coupled Mode Theory (TCMT) for Single Resonance

In various implementations, the optical process in complex resonant structures, such as thermal emitter structure 100, may be described using temporal coupled mode theory (TCMT). The dynamic equations, represented in Equations (2) and (3), may define the modal amplitude and interaction of incoming and outgoing waves within thermal emitter structure 100.

The modal amplitude A may characterize the excitation of the resonance mode, while τᵣ and τₐ may represent the lifetimes associated with radiative loss and non-radiative loss, respectively. The resonance frequency may be denoted as ωᵣ. The incoming wave S₊ and outgoing wave S_ may interact with the resonance mode, where κ is the coupling coefficient between the incoming wave and the modal amplitude A, and d is the coupling parameter that describes how the resonance mode contributes to the outgoing wave. Additionally, the background scattering matrix is represented by the term C. Due to energy conservation and time-reversal symmetry of Maxwell's equations, the coupling coefficients may satisfy the relation κ=

$$d = \sqrt{2 / {τ}_{r}} ,$$

which may close the system of equations and relate the coupling strength to the radiative lifetime.

The interaction between these parameters may influence the absorption properties of thermal emitter structure 100. Equation (5) may describe the absorptance Λ, which may reach a maximum value of unity absorption (Λ=1) when the condition τᵣ=τₐ is satisfied. This scenario may be considered a balanced coupling condition between radiative and non-radiative loss.

$$\frac{dA}{dt} = - i {ω}_{r} A - ( \frac{1}{{τ}_{r}} + \frac{1}{{τ}_{a}} ) A + κ {S}_{+} \qquad ( 2 )$$

$${S}_{-} = {CS}_{+} + dA \qquad ( 3 )$$

$$R = \frac{{( {ω}_{r} - ω )}^{2} + {( \frac{1}{{τ}_{r}} - \frac{1}{{τ}_{a}} )}^{2}}{{( {ω}_{r} - ω )}^{2} + {( \frac{1}{{τ}_{r}} - \frac{1}{{τ}_{a}} )}^{2}} \qquad ( 4 )$$

$$Λ = \frac{\frac{4}{{τ}_{r} {τ}_{a}}}{{( {ω}_{r} - ω )}^{2} + {( \frac{1}{{τ}_{r}} + \frac{1}{{τ}_{a}} )}^{2}} \qquad ( 5 )$$

In various implementations, the resonance properties of thermal emitter structure 100 may be optimized by adjusting the coupling parameters, which may influence the quality factor (Q-factor) and overall emissivity. These theoretical considerations may provide insights into designing high-Q and near-unity emissivity metasurfaces, such as thermal emitter structure 100, for applications that rely on precise thermal radiation control.

### 4. Temporal Coupled Mode Theory (TCMT) for Three Coupled Resonances

In various implementations, the interaction between multiple resonances within thermal emitter structure 100 may be described using temporal coupled mode theory (TCMT). The coupling constant between different resonance modes may be represented as α_{i,j}, where thermal emitter structure 100 may include three coupled resonances. The dynamic equations governing this interaction may be expressed as:

$$\frac{{dA}_{1}}{dt} = - i {ω}_{1} {A}_{1} - ( \frac{1}{{τ}_{r 1}} + \frac{1}{{τ}_{a}} ) {A}_{1} - i {α}_{12} {A}_{2} + {κ}_{1} {S}_{+} \qquad ( 6 )$$

$$\frac{{dA}_{2}}{dt} = - i {ω}_{2} {A}_{2} - ( \frac{1}{{τ}_{r 2}} + \frac{1}{{τ}_{a}} ) {A}_{2} - i {α}_{12} {A}_{1} - i {α}_{23} {A}_{3} + {κ}_{2} {S}_{+} \qquad ( 7 )$$

$$\frac{{dA}_{3}}{dt} = - i {ω}_{3} {A}_{3} - ( \frac{1}{{τ}_{r 3}} + \frac{1}{{τ}_{a}} ) {A}_{3} - i {α}_{23} {A}_{2} + {κ}_{3} {S}_{+} \qquad ( 8 )$$

$${S}_{-} = C {S}_{+} + {d}_{1} {A}_{1} + {d}_{2} {A}_{2} + {d}_{3} {A}_{3} \qquad ( 9 )$$

Applying a harmonic wave expression, where Aⱼ=e^{-iωt}, the frequency domain representation may be written as:

$$i ( {ω}_{1} - ω ) {A}_{1} + ( \frac{1}{{τ}_{r 1}} + \frac{1}{{τ}_{a}} ) {A}_{1} + i {α}_{12} {A}_{2} = {κ}_{1} {S}_{+} \qquad ( 10 )$$

$$i ( {ω}_{2} - ω ) {A}_{2} + ( \frac{1}{{τ}_{r 2}} + \frac{1}{{τ}_{a}} ) {A}_{2} + i {α}_{12} {A}_{1} + i {α}_{23} {A}_{3} = {κ}_{2} {S}_{+} \qquad ( 11 )$$

$$i ( {ω}_{3} - ω ) {A}_{3} + ( \frac{1}{{τ}_{r 3}} + \frac{1}{{τ}_{a}} ) {A}_{3} + i {α}_{23} {A}_{2} = {κ}_{3} {S}_{+} \qquad ( 12 )$$

In some implementations, mode 1 and mode 3 within thermal emitter structure 100 may be considered weakly coupled to free-space radiation. Under this condition, the out-coupling parameters κ₁ and κ₃ may be approximated as negligible (e.g., ≈0), and the terms

$$\frac{1}{{τ}_{r 1}}$$

and

$$\frac{1}{{τ}_{r 3}}$$

may be omitted, as bound states in the continuum (BIC) modes may exhibit significantly longer lifetimes relative to non-radiative loss. Solving for A₁, A₂, A₃ from Equations (10)-(12) and substituting into Equation (9), the expressions for reflectance (R) and absorptance (Λ) may be derived:

$$R = \frac{{( \frac{1}{{τ}_{r 2}} + \frac{1}{{τ}_{a}} + \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2} - {( {ω}_{r} - ω )}^{2} {( 1 + \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2}}{{( {ω}_{r} - ω )}^{2} {( 1 - \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2} + {( \frac{1}{{τ}_{r 2}} + \frac{1}{{τ}_{a}} + \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2}} \qquad ( 13 )$$

$$Λ = \frac{4 ( \frac{1}{{τ}_{r 2}} + \frac{( {α}_{12}^{2} + {α}_{23}^{2} ) \frac{1}{{τ}_{a}}}{{( {ω}_{r} - ω )}^{2} + \frac{1}{{τ}_{a}^{2}}} ) \frac{1}{{τ}_{a}} - 4 {( {ω}_{r} - ω )}^{2} {( \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2}}{{( {ω}_{r} - ω )}^{2} {( 1 - \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2} + {( \frac{1}{{τ}_{r 2}} + \frac{1}{{τ}_{a}} + \frac{( {α}_{12}^{2} + {α}_{23}^{2} ) \frac{1}{{τ}_{a}}}{{( {ω}_{r} - ω )}^{2} + \frac{1}{{τ}_{a}^{2}}} )}^{2}} \qquad ( 14 )$$

In various implementations, at resonance (ωᵣ=ω), achieving near-unity absorptance (Λ=1) may require satisfying the condition of Equation (15):

$$\frac{1}{{τ}_{r 2}} + \frac{( {α}_{12}^{2} + {α}_{23}^{2} ) \frac{1}{{τ}_{a}}}{\frac{1}{{τ}_{a}^{2}}} = \frac{1}{{τ}_{a}} \qquad ( 15 )$$

For frequencies deviating from resonance, the absorptance may decrease significantly, as mode coupling may be absent. In some examples, the coupling constants may be tuned to achieve high-Q resonances and near-unity absorptance in thermal emitter structure 100.

In Equation (15), the term involving the coupling constants α₁₂ and α₂₃ may be regarded as an additional non-radiative loss channel arising from the coupling between the bright mode and the dark modes. This additional loss channel may drive the coupled system closer to the critical coupling condition, where the total effective non-radiative damping rate, including contributions from both intrinsic material loss and the coupling-induced loss, may approach the radiative damping rate. Accordingly, the coupling between the resonances within thermal emitter structure 100 may facilitate achieving near-unity absorptance without requiring that the intrinsic non-radiative loss alone satisfy the critical coupling condition.

These findings may provide insights into the design and optimization of metallic thermal metasurfaces, where multiple coupled resonances may support tailored narrowband emission, high-Q factors, and stable spectral characteristics under varying environmental conditions.

In various implementations, spectrum fitting may be utilized to analyze the spectral characteristics of thermal emitter structure 100. A mathematical model may be applied to fit the experimental spectrum, allowing for the extraction of the Q factor using the expression of Equation (16):

$$Q = \frac{{ω}_{0}}{2 γ} \qquad ( 16 )$$

In Equation (16), ω₀ may represent the resonance frequency, and γ may denote the damping rate of the resonance.

To fit the spectrum obtained from experimental measurements of thermal emitter structure 100, the curve fitting Equation (17) may be expressed as:

$$A = {\vert a + ib + \frac{C}{ω - {ω}_{0} + i γ} \vert}^{2} \qquad ( 17 )$$

In Equation (17), a, b, and C may be constant real numbers, and ω may represent the angular frequency. In various implementations, the curve fitting process may be performed using the “CFTool” toolbox in MATLAB.

During spectrum fitting, the resonance frequency ω₀ may be adjusted slightly to optimize the fitting accuracy. This process may be guided by maximizing the R-squared (R²) value, which may indicate the goodness of fit. In some examples, the R² values of all fitted spectra for thermal emitter structure 100 may exceed 92%, suggesting strong agreement between the model and the experimental data.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A thermal emitter, comprising:
a first metal layer;
an insulator layer disposed on the first metal layer; and
a second metal layer disposed on a surface of the insulator layer opposite the first metal layer, the second metal layer including an array of unit cells;
wherein the thermal emitter is configured to emit electromagnetic radiation from the unit cells when the thermal emitter is heated.

2. The thermal emitter of claim 1, wherein the unit cells of the second metal layer are arranged in a substantially regular array of rows and columns.

3. The thermal emitter of claim 2, wherein the unit cells within each row are evenly spaced apart by a center-to-center distance of about 4 micrometers.

4. The thermal emitter of claim 2, wherein the unit cells within each column are evenly spaced apart by a center-to-center distance of about 4 micrometers.

5. The thermal emitter of claim 1, wherein each unit cell includes a first element and a second element.

6. The thermal emitter of claim 5, wherein a periphery of the first element defines a ring and a periphery of the second element defines a ring arc.

7. The thermal emitter of claim 6, wherein the ring and the ring arc are substantially concentric.

8. The thermal emitter of claim 1, wherein each unit cell includes a first element defining a ring and not a second element.

9. The thermal emitter of claim 1, wherein the first metal layer includes a gold material.

10. The thermal emitter of claim 1, wherein the insulator layer includes a dielectric material.

11. The thermal emitter of claim 10, wherein the dielectric material includes an aluminum oxide material.

12. The thermal emitter of claim 10, wherein the dielectric material includes a dysprosium fluoride material.

13. The thermal emitter of claim 1, wherein the second metal layer includes a gold material.

14. The thermal emitter of claim 2, wherein the rows are substantially orthogonal to the columns.

15. The thermal emitter of claim 2, wherein the rows are substantially parallel to a first pair of opposite lateral edges of the first metal layer.

16. The thermal emitter of claim 2, wherein the columns are substantially parallel to a second pair of opposite lateral edges of the first metal layer.

17. The thermal emitter of claim 2, wherein the unit cells are symmetrical about each row.

18. The thermal emitter of claim 1, wherein the unit cells are formed as discrete patterned structures.

19. A thermal emitter, comprising:
a first metal layer; and
a second metal layer disposed directly on a surface of the first metal layer, the second metal layer including an array of unit cells, wherein no dielectric spacer layer is disposed between the first metal layer and the second metal layer;
wherein the thermal emitter is configured to emit electromagnetic radiation from the unit cells when the thermal emitter is heated.

20. The thermal emitter of claim 19, wherein the unit cells of the second metal layer are arranged in a substantially regular array of rows and columns.
